(19) United States
(12) Patent Application Publication
(10) Pub. No.: US 2009/0024421 A1
(43) Pub. Date: Jan. 22, 2009

(54) Life rewardance insurance system and methodology

(76) Inventors: Charles M. Basner, Clinton Twp., NJ (US); Austin Lett, St. George, UT (US)

Correspondence Address: Kenneth P. Glynn, 24 Mine Street, Flemington, NJ, 08820, US

(21) Appl. No.: 11/879,325

(22) Filed: Jul. 17, 2007

(51) Int. Cl. G06Q 40/00

(52) U.S. Cl. 705/4

(57) ABSTRACT

A life rewardance insurance system that includes managing a pooled insurance plan with the following steps: (a) insuring a plurality of individuals in a plan with a pre-defined set of plan enrollment criteria, the plan having a policy term, and the plan paying to designated beneficiaries of each of the survivors of the plurality of insured individuals enrolled in the plan and not paying to designated beneficiaries of insured individuals who are deceased at the end of the policy term; (b) collecting personal identification and age data from the plurality of insured individuals and maintaining them in confidence from others for at least the duration of the policy term; (c) collecting policy premiums from the plurality of insured individuals; (d) investing premiums as may be specified in the plan; and, (e) making payment to designated beneficiaries of each of the survivors of the plurality of insured individuals enrolled in the plan and not to designated beneficiaries of the deceased.

### BACKGROUND OF INVENTION

a. Field of Invention

The invention relates generally to an insurance system and methodology based on group insurance wherein, after a set time or event has occurred, survivors of the group, or their designees, are the sole beneficiaries of the net proceeds of the pool for their group. Thus, if twenty persons are insured in a group and twelve of those twenty meet their demise before the end of a specified time period or before the occurrence of a specified event or events, then the eight survivors will share the proceeds of the group net pool with themselves or their designees as the pro rata beneficiaries. The net pool proceeds will be made up of the premiums plus growth, minus any fees, administrative costs or agreed upon deductions charged by the provider(s).

b. Description of Related Art

The following patents are representative of financial program reward systems:

U.S. Pat. No. 6,161,096 to Bell which comprises of a method and apparatus for deferred award instrument plan by identifying at least one participant in the deferred award plan, retrieving financial data related to stock options corresponding to the identified participant, computing a spread associated with the retrieved stock options, establishing a rabbi trust with the spread, determining whether a life insurance policy has been purchased by the participant, determining whether a split dollar agreement has been executed, monitoring and paying at least one premium for the life insurance policy and notifying the participants that a payment associated with the life insurance policy has been paid.

U.S. Pat. No. 6,415,267 B1 to Hagan relates to an increasing income financial product. According to one embodiment of the invention, each subscriber invests in a financial contractual product or program. Each subscriber designates primary and secondary beneficiaries. The subscriber has various payment plan options to fund the financial product. Those plans include (a) lump sum payment, (b) periodic payments, (c) a pledge of a subscribers financial asset, and (d) a pledge of a subscribers financial asset accompanied with periodic payments. The primary beneficiary is assigned along with a number of demographically similar beneficiaries, to a certain contract group. In the event the subscriber utilizes the pledge payment plan, when the primary beneficiary dies, the pledged assets of the subscriber are placed under the control of the financial product administrator or its designee. Income is provided according to the contractual terms or parameters to surviving primary beneficiaries of the same assigned contract group on an increasing, survivorship basis until (a) all the initial primary beneficiaries die; or (b) a predetermined percentage of the primary beneficiaries die; (c) the contract expires based upon the expiration of pre-established time periods; or (d) upon any other contractually defined even. Alternatively, the increasing income may be paid to the surviving members based upon mortality tables. When the contract expires, the surviving primary beneficiaries (the percentage initially established per the financial product contract) or the designated secondary beneficiaries receive their pro rata share of the principal form the contract group. In one embodiment, the financial product is configured as a self-directed financial investment wherein the subscriber/primary beneficiary identifies the type of self directed investment structure suitable to him or her and compatible with designated contract group.

U.S. Pat. No. 6,869,362, B2 to Walker et al. describes a method according to some embodiments that provides for a game server to receive policy requirements of a user for a gambling loss insurance policy from a terminal. The game server determines a premium amount based on the policy requirements of the user and transmits information concerning the premium amount to the user.

U.S. Pat. No. 6,950,805 B2 to Kavanaugh relates to a program that administers a method of funding life insurance policies using annuities that are purchased at least in part using borrowed money, using business and trust structures to reduce and/or eliminate tax. This investing can be done either directly by the policy or through the trust and/or other business entity. As an internal investment of the insurance policy the income generated by the annuity and the inside build-up are non-income taxable to the owner of the policy. The resulting death benefits will also be non-income taxable to the beneficiary.

U.S. Pat. No. 7,149,712 B2 to Lang relates a method for financing future intentions of a first party (1,15) pursuant to a first contract (4,18) with a second party (2,16) for a specified monetary sum. A contract (5,19) involving a variable annuity is obtained from a third party (3,17). A guaranteed benefit equal to at least the specified monetary sum is paid to the second party by the third party to pay for the fulfillment of the future intentions of the first party. The variable annuity has a guaranteed annual increase.

Notwithstanding the prior art, the present invention is neither taught nor rendered obvious thereby.

### SUMMARY OF INVENTION

The present invention is a life rewardance insurance system that includes a means for managing a pooled insurance plan. The term “life rewardance” is a new term that refers to life insurance wherein you are paid out for surviving the term of the policy, i.e., for living, instead of being paid out to beneficiaries for dying during the term of the policy. The term “means for managing” is meant to include any means, including computerized systems, manual systems with documents and combinations thereof for initiating the rewardance insurance system, setting terms and conditions (criteria), enrolling insured, collecting personal data, securing personal data, collecting premiums, investing premiums, charging fees where applicable, confirming deaths and survivors, determining payout amounts and making payouts according to the terms and conditions of the policies. Thus, the present invention life rewardance insurance system includes means for managing the following steps: (a) insuring a plurality of individuals in a life rewardance insurance plan wherein the plan has a pre-defined set of plan enrollment criteria, the plan has a policy term, and the plan will pay to designated beneficiaries of each of the survivors of the plurality of insured individuals enrolled in the plan and will not pay to designated beneficiaries of the plurality of insured individuals who are deceased at the end of the policy term; (b) collecting personal identification and age data from the plurality of insured individuals and maintaining confidential storage thereof such that no member of the plurality of insured individuals has access to identification of any of the other members of the plurality of insured individuals as soon as the personal identification and age data is collected and for at least the duration of the policy term (the primary objective is to assure that no one has access to the insureds' personal information except administrators and others with a legal need to know or with a legal right to know.); (c) collecting policy premiums from the plurality of insured individuals; (d) investing premiums as may be specified in the plan; and, (e) making payment to designated beneficiaries of each of the survivors of the plurality of insured individuals enrolled in the plan and not making payment to designated beneficiaries of the plurality of insured individuals who are deceased at the end of the policy term.

In some preferred embodiments of the present invention life rewardance insurance system and methodology, the policy term is for a fixed amount of time. In some preferred embodiments of the present invention life rewardance insurance system and methodology, the policy term is a variable term that will end at an indeterminate time in accordance with pre-set criteria.

In some preferred embodiments of the present invention life rewardance insurance system and methodology, the pre-set criteria for payoff is selected from the group consisting of: (1) the death of a pre-set percentage of the members of the plurality of insured individuals; (2) attainment of a pre-set age by at least one survivor member of the plurality of insured individuals; (3) attainment of a pre-set financial growth objective; (4) occurrence of an external event independent of the rewardance funding and of the plurality of insured individuals; and (5) any combination of the foregoing.

In some preferred embodiments of the present invention life rewardance insurance system and methodology, the plan is set up for a fixed number of insured individuals within a specified age group.

In some preferred embodiments of the present invention life rewardance insurance system and methodology, the plan is set up for a specific gender.

In some preferred embodiments of the present invention life rewardance insurance system and methodology, the policy premiums are fixed for all members of the plurality of insured individuals.

In some preferred embodiments of the present invention life rewardance insurance system and methodology, the policy premiums are variable with a minimum premium requirement for all members of the plurality of insured individuals.

In some preferred embodiments of the present invention life rewardance insurance system and methodology, the plan permits each member of the plurality of insured individuals to designate one or more beneficiaries selected from the group consisting of: (1) the insured; (2) relatives of the insured; (3) unrelated individuals; (4) non-individual legal entities; and (5) combinations of the foregoing.

In some preferred embodiments of the present invention life rewardance insurance system and methodology, the system includes a plurality of diverse plans and the system permits individuals to enroll in one or more than one plan of the system.

In some other embodiments of the present invention life rewardance insurance system, the system includes: (a) a means for managing a pooled insurance plan that includes the following steps: insuring a plurality of individuals in a life rewardance insurance plan wherein the plan has a pre-defined set of plan enrollment criteria, the plan has a policy term, and the plan will pay to designated beneficiaries of each of the survivors of the plurality of insured individuals enrolled in the plan and will not pay to designated beneficiaries of the plurality of insured individuals who are deceased at the end of the policy term; (b) collecting personal identification and age data from the plurality of insured individuals and maintaining confidential storage thereof such that no member of the plurality of insured individuals has access to identification of any of the other members of the plurality of insured individuals for at least the duration of the policy term; (c) collecting policy premiums from the plurality of insured individuals; (d) investing premiums as may be specified in the plan; and, (e) making payment to designated beneficiaries of each of the survivors of the plurality of insured individuals enrolled in the plan and not making payment to designated beneficiaries of the plurality of insured individuals who are deceased at the end of the policy term, wherein the payment is made in accordance with the following formula:

Rᵢ=(Pᵢ/Pₜ)(Pₜ+Gₜ)−(C+E)

wherein Rᵢ equals the rewardance payout to the designated beneficiary or beneficiaries of a member i of the plan who survived the term of the plan; Pᵢ is the premium paid in by member i; Pₜ is the total of paid in premiums by all members of the plan; Gₜ is the total growth from investment of Pₜ; C is any commissions paid to agents, but may be zero; and E are the expenses of the administrator or other plans manager (this could be actual costs plus profits for, e.g., an insurance company, an investment advisor or a registered fund operator. In some preferred embodiments of this present invention life rewardance insurance system and methodology, the policy term is for a fixed amount of time. In some preferred embodiments of this present invention life rewardance insurance system and methodology, the policy term is a variable term that will end at an indeterminate time in accordance with pre-set criteria.

In some preferred embodiments of this present invention life rewardance insurance system and methodology, the pre-set criteria is selected from the group consisting of: (1) the death of a pre-set percentage of the members of the plurality of insured individuals; (2) attainment of a pre-set age by at least one survivor member of the plurality of insured individuals; (3) attainment of a pre-set financial growth objective; (4) occurrence of an external event independent of the rewardance funding and of the plurality of insured individuals; (5) the death of a fixed number of insureds; and (6) any combination of the foregoing.

In some preferred embodiments of this present invention life rewardance insurance system and methodology, the plan is set up for a fixed number of insured individuals within a specified age group.

In some preferred embodiments of this present invention life rewardance insurance system and methodology, the plan is set up for a specific gender.

In some preferred embodiments of this present invention life rewardance insurance system and methodology, the policy premiums are fixed and equal for all members of the plurality of insured individuals.

In some preferred embodiments of this present invention life rewardance insurance system and methodology, the policy premiums are variable, with a minimum premium requirement for all members of the plurality of insured individuals.

In some preferred embodiments of this present invention life rewardance insurance system and methodology, the plan permits each member of the plurality of insured individuals to designate one or more beneficiaries selected from the group consisting of: (1) the insured; (2) relatives of the insured; (3) unrelated individuals; (4) non-individual legal entities; and (5) combinations of the foregoing.

In some preferred embodiments of this present invention life rewardance insurance system and methodology, the system includes a plurality of diverse plans and the system permits individuals to enroll in one or more than one plan of the system at any time.

In addition, the present invention is directed to the methodology that involves managing the life rewardance insurance system in accordance with the steps set forth above.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 shows a schematic diagram of the present invention life rewardance insurance system and methodology in a broad overview presentation;

FIGS. 2 through 8 set forth various embodiments of the present invention life rewardance insurance system and methodology in schematic diagram format.

### DETAILED DESCRIPTION OF THE EMBODIMENTS

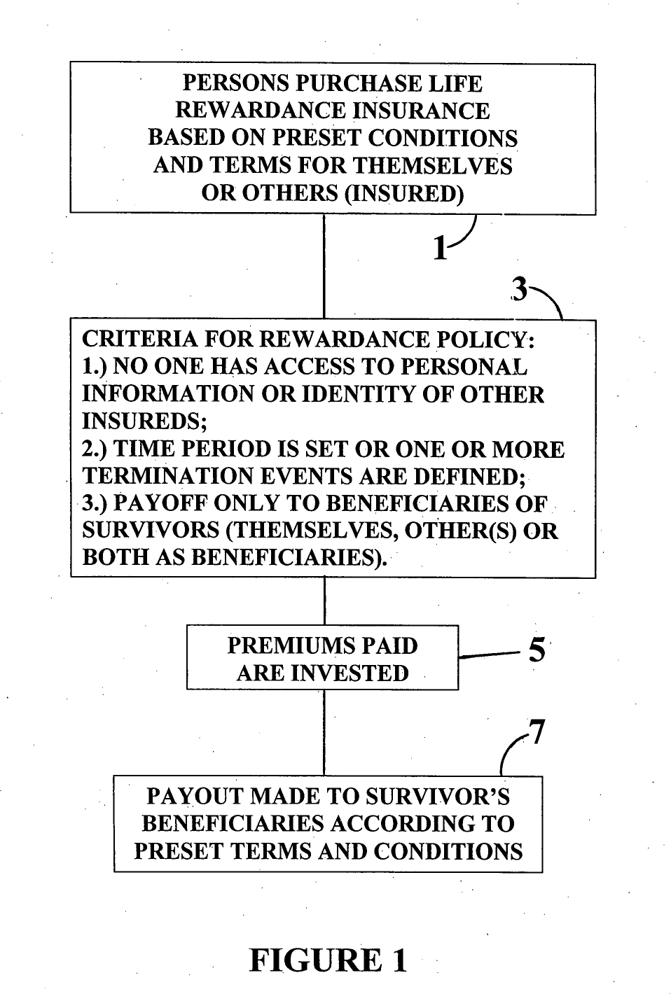

Referring now to the drawings, all of the Figures are schematic block diagrams showing the systems and steps. FIG. 1 shows a schematic diagram of the present invention life rewardance insurance system and methodology in a broad overview presentation. Here, block 1 illustrates the general concept on the life rewardance insurance purchase, block 3 sets forth the criteria for the policy in general terms and block 5 indicates that the premiums are invested. Block 7 is specific to the payout to the survivors' beneficiaries.

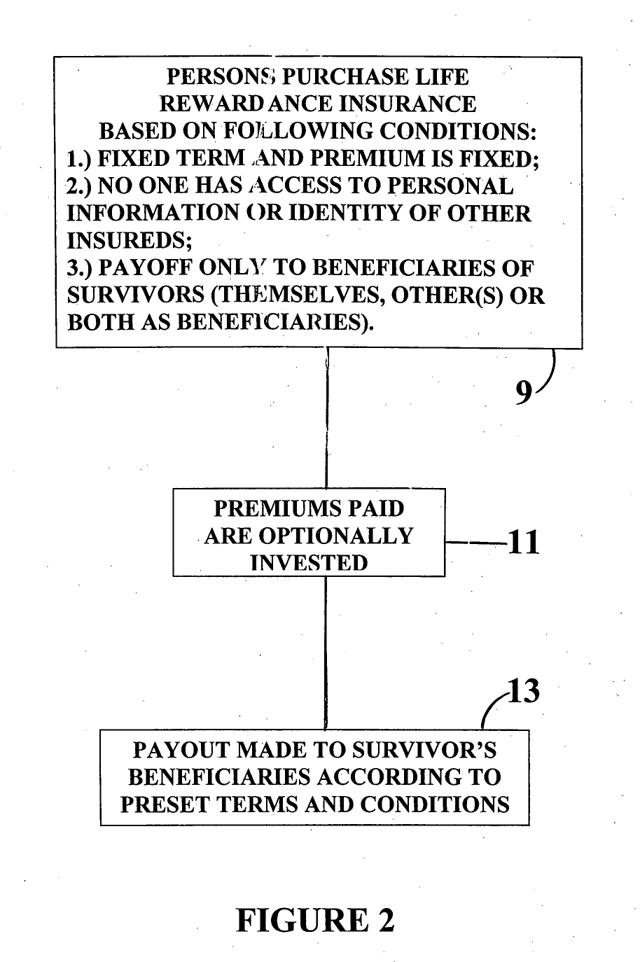

FIGS. 2 through 8 set forth various embodiments of the present invention life rewardance insurance system and methodology in more detail. FIG. 2 sets forth more specific criteria for policy purchase and block 9 specifies fixed term and fixed premium. Block 11 indicates optional investment for growth and block 13 states the payout to survivors' beneficiaries.

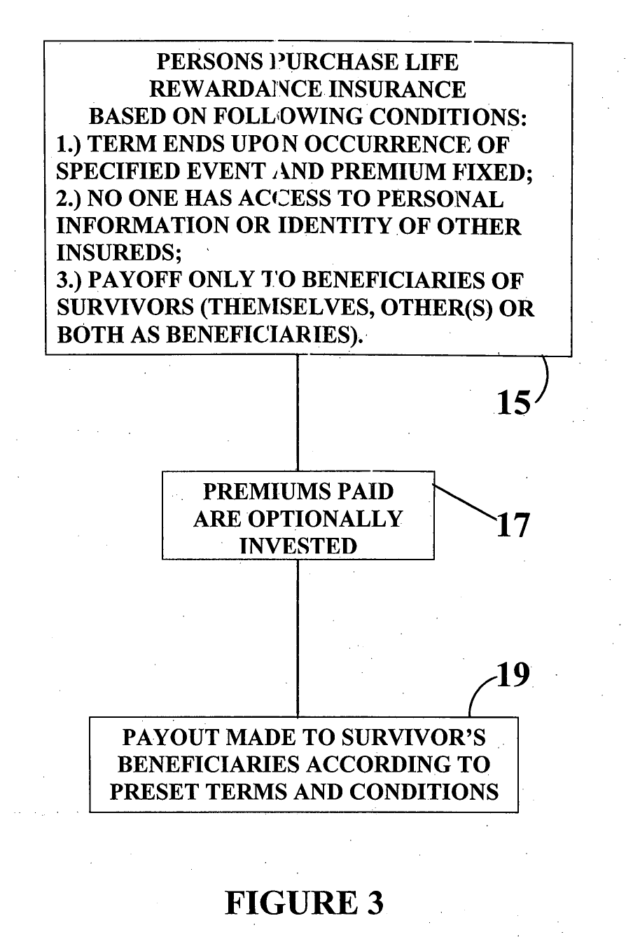

FIG. 3 sets forth specific criteria for policy purchase and block 15 specifies event-based term (not fixed in time) and fixed premium. Block 17 indicates optional investment for growth and block 19 states the payout to survivors' beneficiaries.

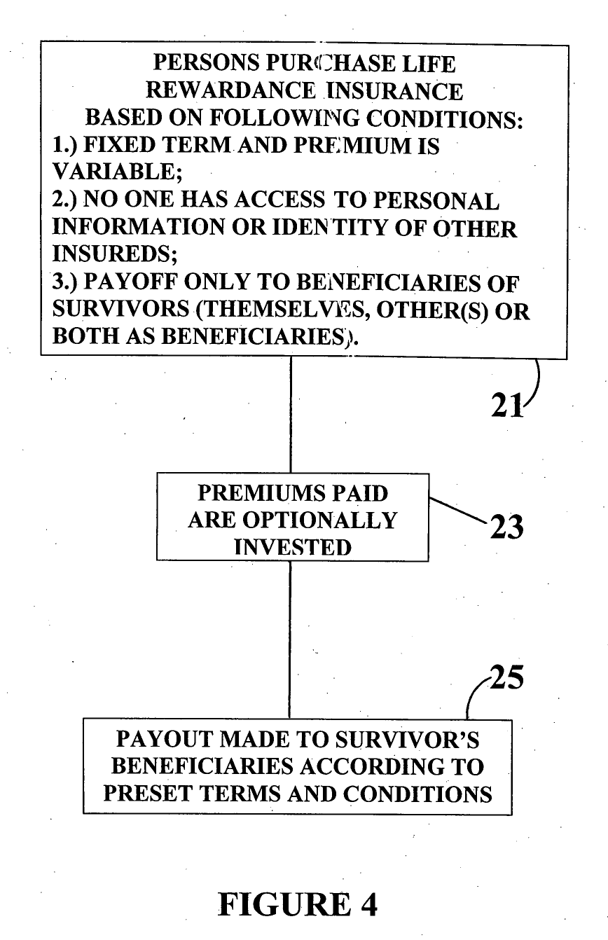

FIG. 4 sets forth specific criteria for policy purchase and block 21 specifies fixed term and variable premium. Typically, a minimum premium is required but insureds may buy in for amounts equal to or greater than the minimum. Block 23 indicates optional investment for growth and block 25 states the payout to survivors' beneficiaries.

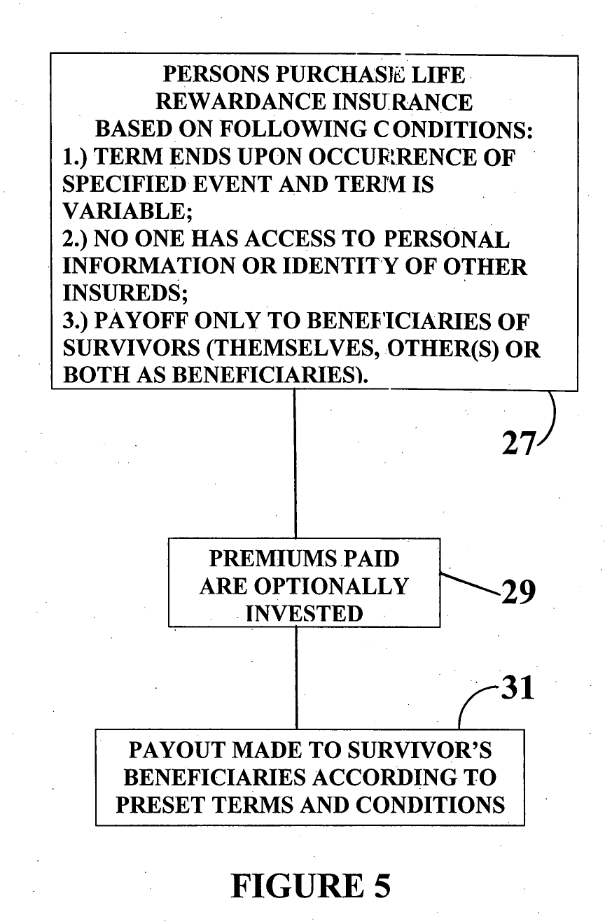

FIG. 5 sets forth specific criteria for policy purchase and block 27 specifies event-based term (not fixed in time) and variable premium. Block 29 indicates optional investment for growth and block 31 states the payout to survivors' beneficiaries.

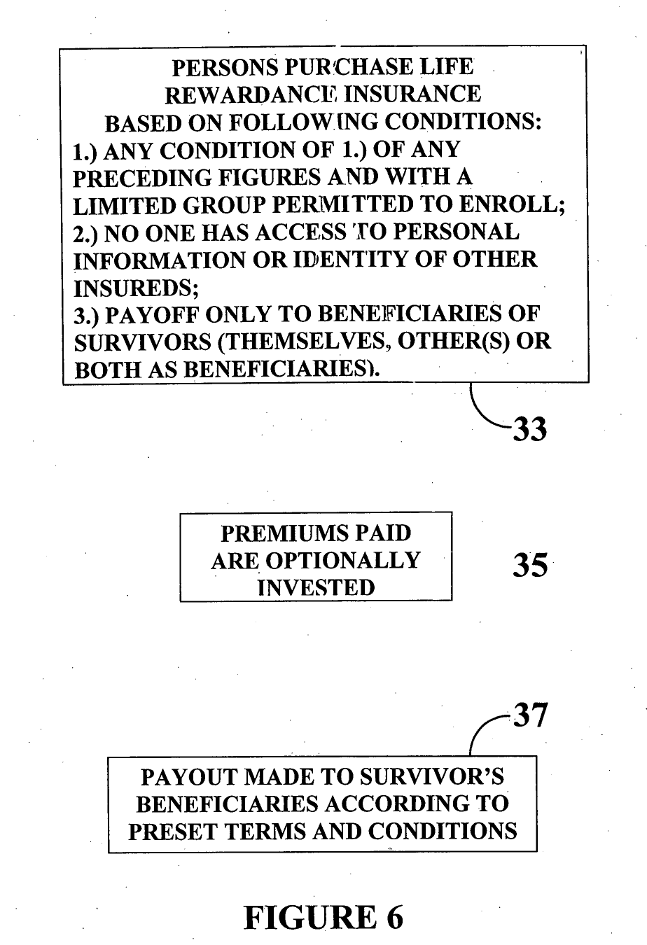

FIG. 6 sets forth specific criteria for policy purchase and block 33 includes any of the preceding Figure paragraph 1.) criteria coupled with the concept that enrollment is limited to a specific group, e.g., members of a fraternal organization, members having a specific minimum income, etc. (In any of the Figures above and below, and examples below, age limitations may be set as well and usually are included in the terms and conditions.) Block 35 indicates optional investment for growth and block 37 states the payout to survivors' beneficiaries.

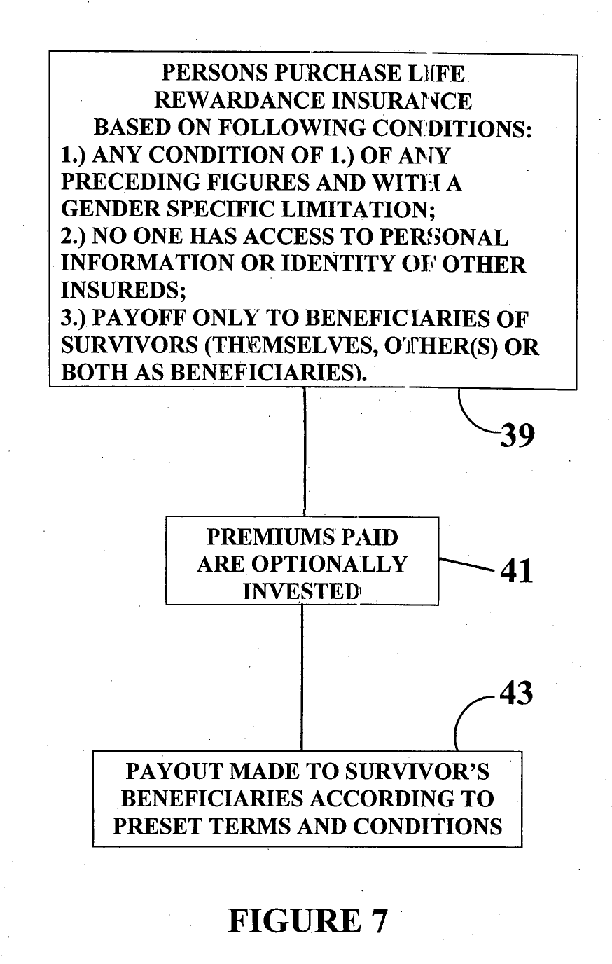

FIG. 7 sets forth specific criteria for policy purchase and block 39 includes any of the preceding Figure paragraph 1.) criteria coupled with the concept that enrollment is limited to a gender specific group, e.g., females. Block 41 indicates optional investment for growth and block 43 states the payout to survivors' beneficiaries.

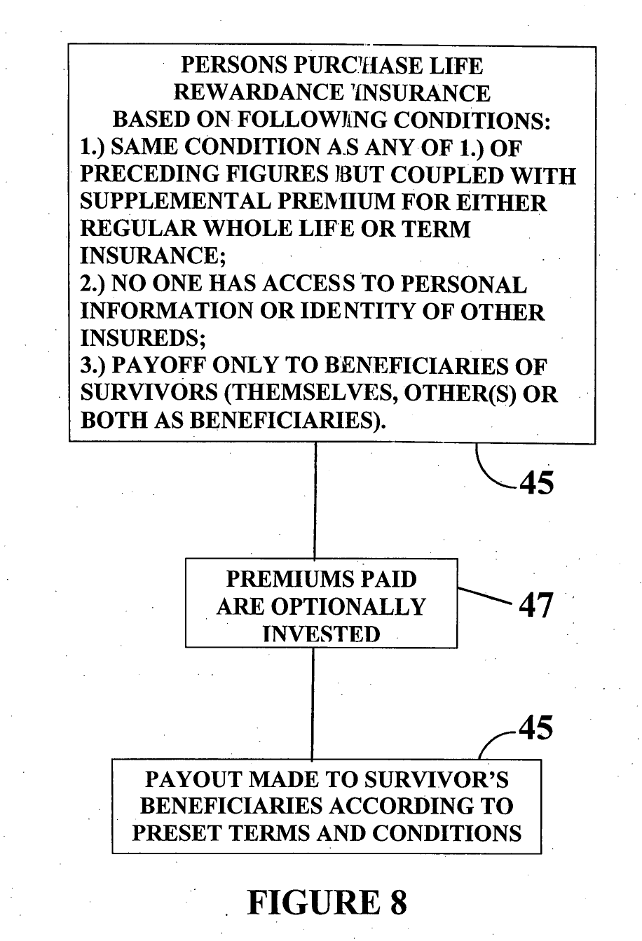

FIG. 8 sets forth specific criteria for policy purchase and block 45 includes any of the preceding Figure paragraph 1.) criteria coupled with the concept that there may also be a regular whole life or term insurance policy for payout to those who meet their demise during the term. This is ancillary to the primary purpose of the life rewardance insurance. Block 47 indicates optional investment for growth and block 49 states the payout to survivors' beneficiaries.

The following examples further illustrate the present invention system and methodology:

### EXAMPLE 1

### Full Fixed Program

The policy pool is limited to a fixed number of insured persons. For a fixed dollar amount of insurance for a fixed term. Seven pools are set up for age brackets 51-52, 53-54, 55-56, 57-58, 59-60, 61-62, and 63-64, based on age at commencement of policy, Jul. 7, 2007. Each policy has a premium cost of $15,000.00 and has a term of ten years. Each insured may name himself/herself as beneficiary or may name someone else. If an insured passed away on or before midnight of Jul. 6, 2017, then that insured is eliminated from the pool and there is no payout to that insured's beneficiary. The payout is only to the beneficiary of the surviving insured who survive the policy term. The payout is prorated by the number of surviving insured divided by the total number of insured, namely, 100, less processing fees. The payout is based on a starting fund of $1,500,000.00 plus growth from fund investment, in this case $1,200,000.00 net appreciation of investment. So if 30 insured survive the term of the policy, the payout to each insured beneficiary is $2,700,000.00 multiplied by 30 over 100, or $81,000.00 per surviving insured.

### EXAMPLE 2

### Open Season Fixed Program

The policy pool is unlimited as to the number of insured persons, but each must enroll before a fixed deadline or policy commencement date. The dollar amount of the premium is fixed, the age brackets are fixed and the term is fixed. The payout is based on the total net premium and net investment growth (“end fund”) multiplied by the number of insured surviving the policy term divided by the total number of insured who initially enrolled.

### EXAMPLE 3

### Partial Fixed Variable Term

This is the same as Example 1 except that the term is not for a fixed term, as ten years, but instead is variable, based on some event that is defined, but indeterminate at the time of the policy commencement. Thus, the term might be defined to end when ⅔ of the insured have met their demise. Alternatively, the term might be defined by some other parameter, for example, when the end fund reaches a fixed value or a multiple of the original value, e.g. 1.5. It might be based on a term that ends when the first of the insured reaches a specified age, e.g. 70 years of age.

### EXAMPLE 4

### Open Season, Partial Fixed, Variable Term

The policy pool is limited to a fixed number of insured persons, but each must enroll by a fixed deadline or policy commencement date. The term is a variable term as set forth in Example 3 above.

### EXAMPLE 5

### Variable Premium

Any of the possibilities of Examples 1 through 5 above may be used in this example, except that the premium is not fixed. Thus, a member may purchase a minimum dollar amount policy or a policy for any amount desired above the minimum. If the insured survives the time or event ending the term, the distribution pool will be pro rata, based on the premium purchase price and the dates on which the premiums were purchased.

### EXAMPLE 6

### Gender Specific Plan

This Example involves a plan that may incorporate any of the above features, but is gender specific. Thus, the plan would be limited only to females of the required age group or males of the required age group.

### EXAMPLE 7

### Group Specific Plan

This Example may be directed to any plan set forth above but may be limited to members of a specific group, such as military veterans, union members of a specific union, people having a common illness or people who are already insured with a hosting insurance company.

### EXAMPLE 8

### Butterfly Hedge Plan

Any of the plans set forth in the Examples above may be included in this plan, except that, additionally, this plan includes a supplemental premium for either whole life or term insurance on the member of the plan. Thus, if the member dies during the term, the whole life or term insurance feature will pay the beneficiaries, although the rewardance pool portion will be forfeited. If the member survives the term, the life insurance will expire without a payoff but the rewardance pool will result in a payout to the members beneficiaries.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. For example, while insurance policies generally have a short “open season” for enrollment in a group and any of the insured have basically the same term, in the present invention life rewardance insurance systems and methodologies, in some cases, enrollment is opened for a fixed, short enrollment season, while in other plans within the scope for the present invention, the enrollment period may be for a significantly extended period, e.g., the first eight years of a ten year term, and time-based formulas must be utilized to prorate possible outcomes for survivor payouts. Thus an insured coming in during the middle of a term and paying half the premium of another insured might receive only 25% of the proceeds relative to the aforesaid insured if both survive. In another example, if two insureds purchase the same premium, but one comes in much later, a formula will determine how much less that second-to-come insured would receive as a survivor. Such a formula might simply be time ratio based or it could have other factors such as changing prime rates. Further, in some cases premiums may be random, in some cases they may be one time fixed and in other cases there may be periodic payments.

What is claimed is:

1. A life rewardance insurance system, which comprises:
a means for managing a pooled insurance plan that includes the following steps:
i) insuring a plurality of individuals in a life rewardance insurance plan wherein said plan has a pre-defined set of plan enrollment criteria, said plan has a policy term, and said plan will pay to designated beneficiaries of each of the survivors of the plurality of insured individuals enrolled in said plan and will not pay to designated beneficiaries of said plurality of insured individuals who are deceased at the end of said policy term;
ii) collecting personal identification and age data from said plurality of insured individuals and maintaining confidential storage thereof such that no member of said plurality of insured individuals has access to identification of any of the other members of said plurality of insured individuals for at least the duration of the policy term;
iii) collecting policy premiums from said plurality of insured individuals;
iv) investing premiums as may be specified in the plan; and,
v) making payment to designated beneficiaries of each of the survivors of said plurality of insured individuals enrolled in said plan and not making payment to designated beneficiaries of said plurality of insured individuals who are deceased at the end of said policy term.

2. The life rewardance insurance system of claim 1 wherein said policy term is for a fixed amount of time.

3. The life rewardance insurance system of claim 1 wherein said policy term is a variable term that will end at an indeterminate time in accordance with pre-set criteria.

4. The life rewardance insurance system of claim 3 wherein said pre-set criteria is selected from the group consisting of: (1) the death of a pre-set percentage of said members of said plurality of insured individuals; (2) attainment of a pre-set age by at least one survivor member of said plurality of insured individuals; (3) attainment of a pre-set financial growth objective; (4) occurrence of an external event independent of the rewardance funding and of the plurality of insured individuals; (5) the death of a fixed number of insureds; and (6) any combination of the foregoing.

5. The life rewardance insurance system of claim 1 wherein said plan is set up for a fixed number of insured individuals within a specified age group.

6. The life rewardance insurance system of claim 1 wherein said plan is set up for a specific gender.

7. The life rewardance insurance system of claim 1 wherein said policy premiums are fixed and equal for all members of said plurality of insured individuals.

8. The life rewardance insurance system of claim 1 wherein said policy premiums are variable, with a minimum premium requirement for all members of said plurality of insured individuals.

9. The life rewardance insurance system of claim 1 wherein said plan permits each member of said plurality of insured individuals to designate one or more beneficiaries selected from the group consisting of: (1) the insured; (2) relatives of the insured; (3) unrelated individuals; (4) non-individual legal entities; and (5) combinations of the foregoing.

10. The life rewardance insurance system of claim 1 wherein said system includes a plurality of diverse plans and the system permits individuals to enroll in one or more than one plan of said system at any time.

11. A life rewardance insurance system, which comprises:
a means for managing a pooled insurance plan that includes the following steps:
i) insuring a plurality of individuals in a life rewardance insurance plan wherein said plan has a pre-defined set of plan enrollment criteria, said plan has a policy term, and said plan will pay to designated beneficiaries of each of the survivors of the plurality of insured individuals enrolled in said plan and will not pay to designated beneficiaries of said plurality of insured individuals who are deceased at the end of said policy term;
ii) collecting personal identification and age data from said plurality of insured individuals and maintaining confidential storage thereof such that no member of said plurality of insured individuals has access to identification of any of the other members of said plurality of insured individuals for at least the duration of the policy term;
iii) collecting policy premiums from said plurality of insured individuals;
iv) investing premiums as may be specified in the plan; and,
v) making payment to designated beneficiaries of each of the survivors of said plurality of insured individuals enrolled in said plan and not making payment to designated beneficiaries of said plurality of insured individuals who are deceased at the end of said policy term, wherein said payment is made in accordance with the following formula:
Rᵢ=(Pᵢ/Pₜ)(Pₜ+Gₜ)−(C+E)
wherein Rᵢ equals the rewardance payout to the designated beneficiary or beneficiaries of a member i of the plan who survived the term of the plan; Pᵢ is the premium paid in by member i; Pₜ is the total of paid in premiums by all members of the plan; Gₜ is the total growth from investment of Pₜ; C is any commissions paid to agents, but may be zero; and E are the expenses of the administrator or other plans manager (this could be actual costs plus profits for, e.g., an insurance company, an investment advisor or a registered fund operator), but may be zero.

12. The life rewardance insurance system of claim 11 wherein said policy term is for a fixed amount of time.

13. The life rewardance insurance system of claim 11 wherein said policy term is a variable term that will end at an indeterminate time in accordance with pre-set criteria.

14. The life rewardance insurance system of claim 13 wherein said pre-set criteria is selected from the group consisting of: (1) the death of a pre-set percentage of said members of said plurality of insured individuals; (2) attainment of a pre-set age by at least one survivor member of said plurality of insured individuals; (3) attainment of a pre-set financial growth objective; (4) occurrence of an external event independent of the rewardance funding and of the plurality of insured individuals; (5) the death of a fixed number of insureds; and (6) any combination of the foregoing.

15. The life rewardance insurance system of claim 11 wherein said plan is set up for a fixed number of insured individuals within a specified age group.

16. The life rewardance insurance system of claim 11 wherein said plan is set up for a specific gender.

17. The life rewardance insurance system of claim 11 wherein said policy premiums are fixed and equal for all members of said plurality of insured individuals.

18. The life rewardance insurance system of claim 11 wherein said policy premiums are variable, with a minimum premium requirement for all members of said plurality of insured individuals.

19. The life rewardance insurance system of claim 11 wherein said plan permits each member of said plurality of insured individuals to designate one or more beneficiaries selected from the group consisting of: (1) the insured; (2) relatives of the insured; (3) unrelated individuals; (4) non-individual legal entities; and (5) combinations of the foregoing.

20. The life rewardance insurance system of claim 11 wherein said system includes a plurality of diverse plans and the system permits individuals to enroll in one or more than one plan of said system at any time.

21. A life rewardance insurance methodology, which comprises:
managing a pooled insurance plan that includes the following steps:
i) insuring a plurality of individuals in a life rewardance insurance plan wherein said plan has a pre-defined set of plan enrollment criteria, said plan has a policy term, and said plan will pay to designated beneficiaries of each of the survivors of the plurality of insured individuals enrolled in said plan and will not pay to designated beneficiaries of said plurality of insured individuals who are deceased at the end of said policy term;
ii) collecting personal identification and age data from said plurality of insured individuals and maintaining confidential storage thereof such that no member of said plurality of insured individuals has access to identification of any of the other members of said plurality of insured individuals for at least the duration of the policy term;
iii) collecting policy premiums from said plurality of insured individuals;
iv) investing premiums as may be specified in the plan; and,
v) making payment to designated beneficiaries of each of the survivors of said plurality of insured individuals enrolled in said plan and not making payment to designated beneficiaries of said plurality of insured individuals who are deceased at the end of said policy term.

22. The life rewardance insurance methodology of claim 21 wherein said policy term is for a fixed amount of time.

23. The life rewardance insurance methodology of claim 21 wherein said policy term is a variable term that will end at an indeterminate time in accordance with pre-set criteria.

24. The life rewardance insurance methodology of claim 23 wherein said pre-set criteria is selected from the group consisting of: (1) the death of a pre-set percentage of said members of said plurality of insured individuals; (2) attainment of a pre-set age by at least one survivor member of said plurality of insured individuals; (3) attainment of a pre-set financial growth objective; (4) occurrence of an external event independent of the rewardance funding and of the plurality, of insured individuals; (5) the death of a fixed number of insureds; and (6) any combination of the foregoing.

25. The life rewardance insurance methodology of claim 21 wherein said plan is set up for a fixed number of insured individuals within a specified age group.

26. The life rewardance insurance methodology of claim 21 wherein said plan is set up for a specific gender.

27. The life rewardance insurance methodology of claim 21 wherein said policy premiums are variable and equal with a minimum premium requirement for all members of said plurality of insured individuals.

28. The life rewardance insurance methodology of claim 21 wherein said plan permits each member of said plurality of insured individuals to designate one or more beneficiaries selected from the group consisting of: (1) the insured; (2) relatives of the insured; (3) unrelated individuals; (4) non-individual legal entities; and (5) combinations of the foregoing.

29. The life rewardance insurance methodology of claim 21 wherein said system includes a plurality of diverse plans and the system permits individuals to enroll in one or more than one plan of said system at any time.

30. The life rewardance insurance methodology of claim 21 wherein step iv) involves making payment to designated beneficiaries of each of the survivors of said plurality of insured individuals enrolled in said plan and not making payment to designated beneficiaries of said plurality of insured individuals who are deceased at the end of said policy term, wherein said payment is made in accordance with the following formula:
Rᵢ=(Pᵢ/Pₜ)(Pₜ+Gₜ)−(C+E)
wherein Rᵢ equals the rewardance payout to the designated beneficiary or beneficiaries of a member i of the plan who survived the term of the plan; Pᵢ is the premium paid in by member i; Pₜ is the total of paid in premiums by all members of the plan; Gₜ is the total growth from investment of Pₜ; C is any commissions paid to agents, but may be zero; and E are the expenses of the administrator or other plans manager (this could be actual costs plus profits for, e.g., an insurance company, an investment advisor or a registered fund operator), but may be zero.
